(19) United States
(12) Patent Application Publication
(10) Pub. No.: US 2010/0214870 A1
(43) Pub. Date: Aug. 26, 2010

(54) METHOD AND APPARATUS FOR DYNAMIC EXTRACTION OF EXTREMA-BASED GEOMETRIC PRIMITIVES IN 3D VOXEL VOLUMES

(76) Inventors: Randolph Pepper, Beijing (CN); Gang Fan, Beijing (CN); Terje Iversen, Beijing (CN); Dong Wang, Beijing (CN)

Correspondence Address: HOFFMAN WARNICK LLC, 75 STATE STREET, 14TH FLOOR, ALBANY, NY, 12207, US

(21) Appl. No.: 12/390,555

(22) Filed: Feb. 23, 2009

(51) Int. Cl. G01V 1/28

(52) U.S. Cl. 367/72

(57) ABSTRACT

Methods and systems for investigating subterranean formations are disclosed. A method for extracting geological horizon on-demand from a 3D seismic data set, comprises collecting 3D seismic data and generating 3D seismic extrema cubes; obtaining a user-defined seed point in the 3D seismic data set; determining a starting extrema point for extracting the geological horizon, wherein the starting extrema point is associated with the seed point; growing an extrema patch consisting of multiple extrema points from multiple traces, wherein the growth begins from the starting extrema point; capturing statistics of the growing extrema patch; and outputting the extrema patch as the geological horizon, including spatial and attribute statistics. The geological horizon is incorporated into a collection with other geological horizons for subsequent analysis and interpretation for areal extent through combining geological horizon segments and geochronologic ordering based on positional overlapping of geological horizon segments.

### BACKGROUND OF INVENTION

1. Field of the Invention

This invention relates to the field of seismic data interpretation. In particular, the invention relates to an apparatus and method for automatic extraction of interpretation primitives from 3D voxel volume.

2. Background Art

Seismic data acquisition and processing are key components in geophysical exploration. In a seismic survey, formation layers, lithological boundaries, sedimentary bedding, etc. can be defined through the interface between different formation layers, which produces seismic reflections due to impedance contrast.

Seismic reflections are referred as seismic horizons, which is important in structural characterization of 3D seismic data. Seismic horizons are commonly interpreted as being located along minimum, maximum, or zero crossing value in a seismic volume. Various seismic data processing methods, including manual interpretation and automatic extraction of the seismic horizon have been developed. U.S. Pat. No. 7,248,539, issued to Borgos et al., discloses a method of automatic seismic reflector interpretation and fault displacement calculations. By classifying the seismic waveform around the reflectors, an improved automatic interpretation will be gained. According to Borgos's method, the seismic waveform around the extrema positions can be represented by a set of coefficients, which can be input into the classification process. Such a one-point support for the reconstruction is an important element in the classification of seismic reflectors, as it allows the classification to be performed only along extrema position while utilizing information regarding the waveforms in intervals around the extrema positions. The number of data points to be classified will be thereby reduced and allowing the 3D classification to be run on a sparse 3D volume.

The coefficients and “extrema” indicates characteristics of seismic traces, are used to track the position of seismic horizons, such as minimum values, maximum values, zero-crossing values, midpoints between zero-crossing values and maximum or minimum values, etc.

U.S. patent publication No. 2008/0140319 discloses a method of processing stratigraphic data, which comprises extending a plurality of spaced sampling traces through the volume to traverse the stratigraphic features; and assigning the stratigraphic features respective relative geological ages such that, on each sampling trace, the relative geological age of each stratigraphic feature traversed by the sampling trace in the direction from geologically younger to geologically older stratigraphic features is increased in relation to the relative geological age of its preceding stratigraphic feature, under the condition that each stratigraphic feature takes the same relative geological age across all the sampling traces by which it is traversed.

Those existing procedures includes extrema detection, horizon segment generation. However, there is still a need for methods and systems that would allow a user to more easily add or modify horizons in a defined seismic volume of interest.

### SUMMARY OF INVENTION

In one aspect, the present invention relates to methods for data processing, particularly data represented in three dimensions (3D). A method in accordance with one embodiment of the invention includes opening an existing interpretation collection that is desired to be updated, previewing extrema points of the existing interpretation collection, locating an interested area (point) by picking a seed point on an intersection plane, and generating a new geological horizon according to the picked seed point. In some embodiments, the method further comprises inputting user defined parameters before determining a starting extrema, adding the starting extrema point to an extrema patch; determining whether all traces around the boundary of the extrema patch have been visited, and if so, outputting the extrema patch as the geological horizon; and if not all traces around the boundary of the extrema patch have been visited, selecting a trace nearby and extracting extrema point near the seed point; determining whether there is an extrema point matching user-defined parameters, and if matches, adding the matching extrema point to the growing extrema patch; if it does not match, go back to the step of determining whether all traces around the boundary of the extrema patch have been visited; and repeating the step of determining whether all traces around the boundary of the extrema patch have been visited. In some embodiments, the newly generated geological horizon will be added to the existing interpretation collection. In some embodiments, the newly generated horizon will be readily for horizon merging, geo-time sorting and classifying.

In another aspect, the present invention relates to systems for analyzing formation property data. A system in accordance with one embodiment of the invention includes a processor and a memory, wherein the memory stores a program having instructions for: collecting a volume of interest from 3D seismic data; extracting geological horizon segments that include multiple geological horizons by generating and classifying 3D seismic extrema cubes corresponding to the volume of interest; dynamic extracting a geological horizon from the 3D seismic data by using a user defined seed point to guide extraction; and incorporating the geological horizon segments generated from extrema cubes and the geological horizon generated from the seed point. In some embodiments, the new geological horizon generated from the seed point will be incorporated with the geological horizon segments generated from the extrema cubes so as to form geological horizon primitives or to form an integrated geological horizon exploration. In some embodiments, the new geological horizon generated from the seed point replaces one of the geological horizons of an existing geological horizon set, so as to update the geological horizon exploration.

Another aspect of the invention relates to a computer-readable medium storing a program having instructions for: obtaining a user-defined seed point in 3D seismic data; determining a starting extrema point for the geological horizon extraction, wherein the starting extrema point is associated with the seed point; growing an extrema patch consisting of multiple extrema points from multiple traces, wherein the growth begins from the starting extrema; and outputting the extrema patch as the geological horizon.

Another aspect of the invention relates to a computer-readable medium storing a program having instructions for: collecting a volume of interest from 3D seismic data; extracting geological horizon segments that including multiple geological horizons by generating and classifying 3D seismic extrema cubes corresponding to the volume of interest; dynamic extracting a geological horizon from the 3D seismic data by using a user defined seed point to guide extraction; and incorporating the geological horizons segments generated from extrema cubes and the geological horizon generated from the seed point.

Other aspects and advantages of the invention will become apparent from the following description and the attached claims.

### BRIEF SUMMARY OF THE DRAWINGS

FIG. 1 shows a example of a seismic volume containing a collection of geometric primitives.

FIG. 2 shows a process of seismic exploration according to one embodiment of the present invention.

FIG. 3 shows a process of dynamically extracting horizon on demand of a user in accordance with one embodiment of the invention.

FIG. 4a-4d show a display of a horizon growing from a seed point in accordance with one embodiment of the invention.

FIG. 5a-5d shows a display of extracted horizon in conditions of various predetermined extrema parameters in accordance with one embodiment of the invention.

### DETAILED DESCRIPTION

Embodiments of the invention relate to methods and systems for data processing, particularly data represented in three dimensions (3D). Embodiments of the invention are particularly useful in processing data obtained from oil and gas exploration, such as seismic prospecting. For clarity, the following description may use seismic data prospecting to describe embodiments of the invention. However, one of ordinary skill in the art would appreciate that embodiments of the invention may also be applied to other types of data.

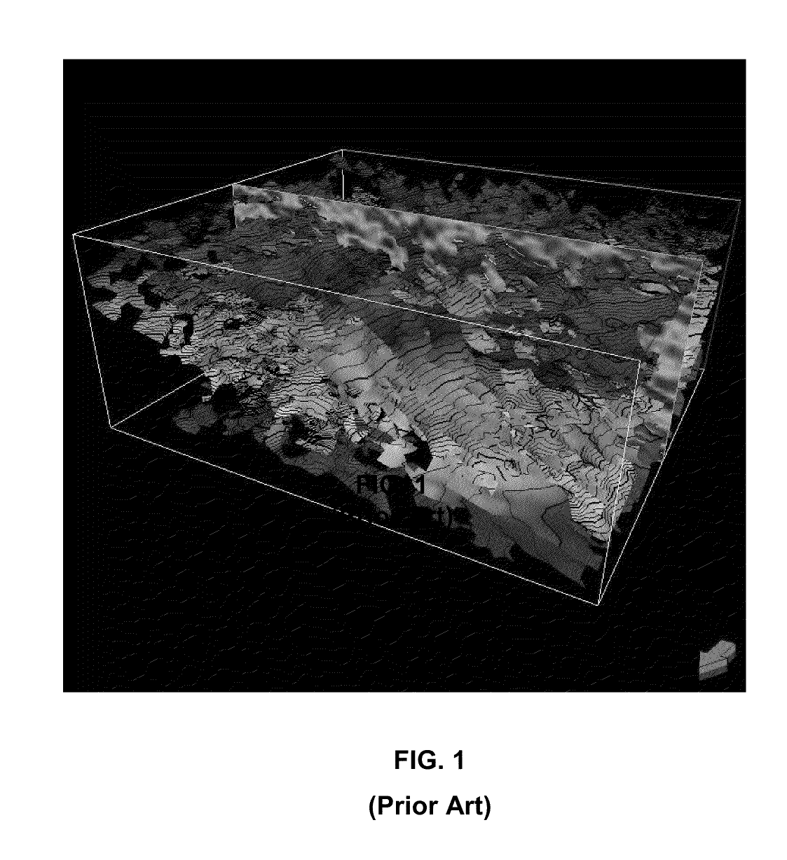

FIG. 1 shows an example of a seismic volume containing a collection of geometric primitives (such as seismic horizon patches). It is clear from FIG. 1 that seismic data are voluminous and very complicated. Manually identify or classify relevant geological features from such data volume would be very hard and time consuming. Automatic identify and classify data from 3D data volume is disclosed in U.S. Pat. No. 7,248,539 issued to Borgos et al., the entire teaching is incorporated herein as reference.

Embodiments of the invention provide methods to facilitate modifying an existing 3D data set, such as an existing seismic data horizon set shown in FIG. 1. Methods of the invention represent an improvement over existing extrema classification method (such as that disclosed in U.S. Pat. No. 7,248,539 issued to Borgos et al.). Methods of the invention provide an approach to change parameters or add horizons to an existing seismic data horizon set, eliminating the trouble to re-define the seismic volume of interest or to repeat the whole seismic extraction process again. More specifically, when a desired existing horizon set is opened by a user, an interested area (point) can be located by manipulating the intersection plane, previewing extrema points and choosing a seed point by a user input, and a new horizon will be generated in accordance with the user input. The newly generated horizon can be added to the existing horizon set and is readily for further operations, such as horizon merging, geo-time sorting and classifying.

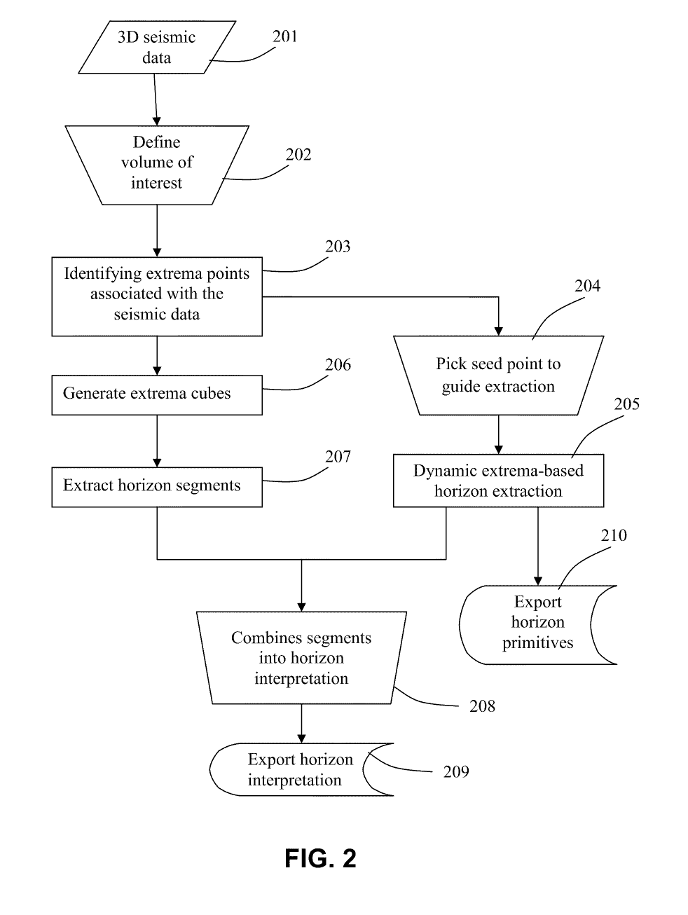

Embodiments of the invention relate to an iteration extraction method to generate/modify horizon interpretation on a computer workstation. As shown in FIG. 2, a method or workflow in accordance with one embodiment of the invention can be described as beginning with step of collecting 3D seismic data (step 201). For example, the collection of 3D seismic data may include seismic data obtained through the reflection of subsurface.

As shown in FIG. 2, a user defines a volume of interest in the collection of 3D seismic data (step 202). A plurality of extrema points associated with the 3D seismic data will be identified and the positions of those extrema points will be calculated (step 203). As disclosed in U.S. Pat. No. 6,240,370, spectrum decomposition is applied to reflected signal by using orthogonal polynomials, generating a reconstructed trace from the seismic data trace and calculating precise positions and amplitudes of the extrema points. Extrema cubes will then be generated in the volume of interest (step 206). As disclosed in U.S. Pat. No. 7,248,539 issued to Borgos et al., extrema cubes can contain the amplitudes at the extrema points and the exact positions of the extrema points. Then, geological horizon segments will be extracted by classifying extrema in a sparse 3D volume and obtaining spatially continuous surface segments (patches) that belong to a same extrema class extracted from extrema cubes (step 207).

As shown in FIG. 2, a user may also pick a seed point in the collection of 3D seismic data to guide the geological horizon extraction (step 204). According to the seed point picked by the user, a geological horizon will be dynamically extracted from the 3D seismic data, based on the position of the extrema point near the seed point and user defined parameters, such as, tolerance, visible faults, etc. (step 205). Primitives of the geological horizon extracted by step 205 will then be exported (step 210). Also, the extracted horizon results from step 205 will be combined with the horizon segments results from step 207, and forming a interpretation collection of the seismic volume of interest (step 208). Then exporting the interpretation collection (step 209).

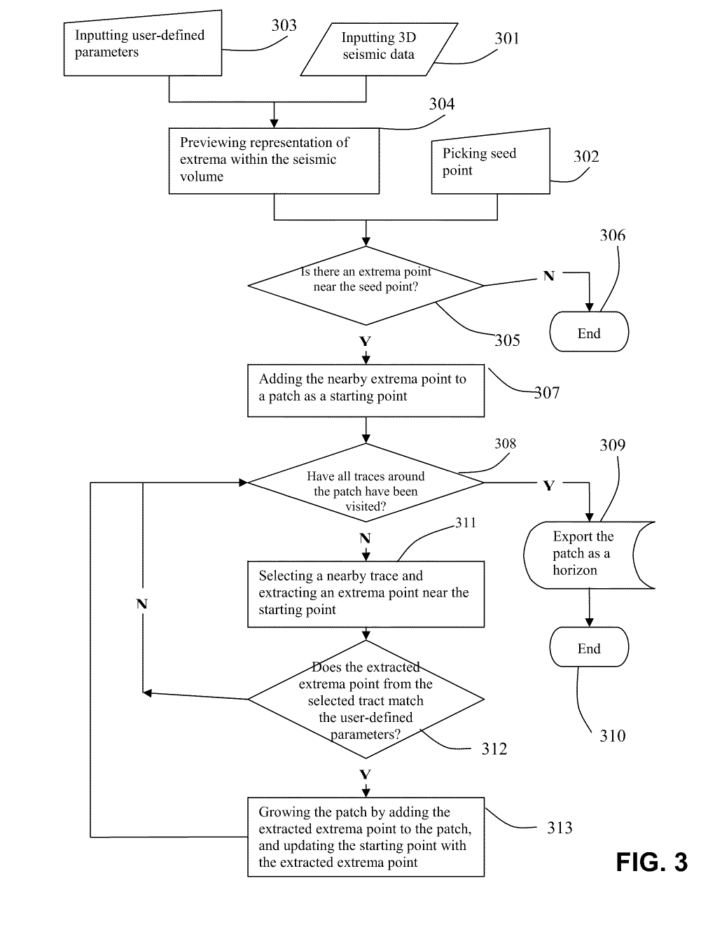

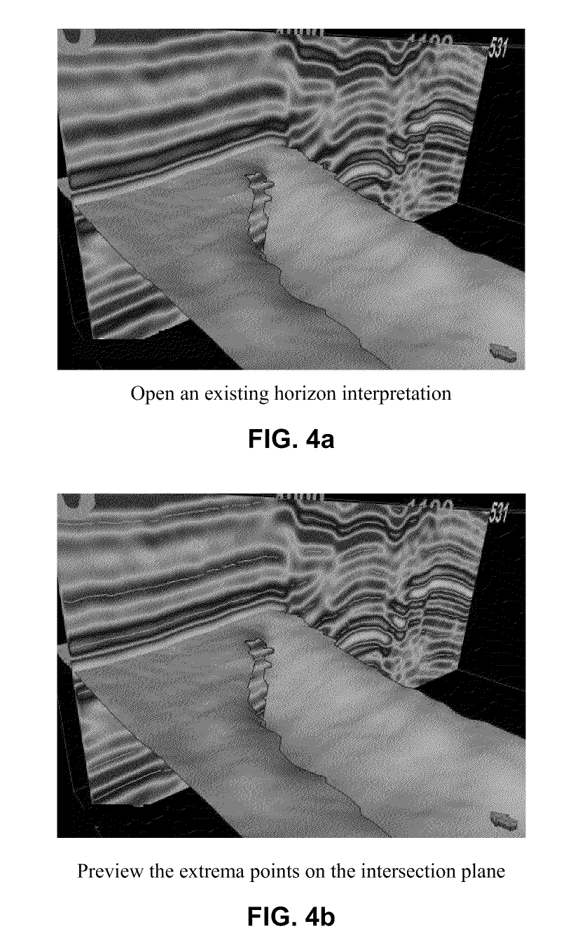

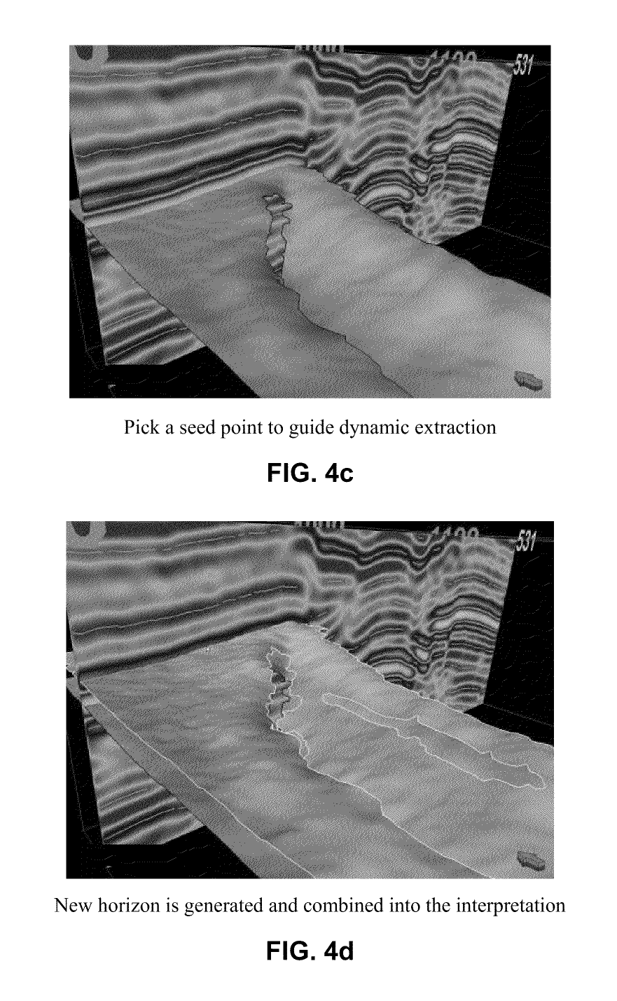

Steps of picking seed point (step 204) and dynamic geological horizon extraction (step 205) will be more specifically described by reference of FIG. 3. As shown in FIG. 3, the first step is inputting 3D seismic data, and generating a 3D extrema cube corresponding to the inputting 3D seismic data (step 301). As shown in FIG. 4a, one horizon of an existing horizon interpretation extends from a extrema line associated with a vertical section plane of the seismic volume of interest. While the figures shown throughout this patent application are depicted in grey-scale, it will be understood that color display of this information are customary and are preferable for many types of applications.

Parameters necessary for implementing the method of the present invention are input by the user (step 303), which includes, but not limit to, max slope (acceptable maximum z-value variation near two neighbor extrema), confidence/tolerance (the maximum quality change between two nearby neighbor extrema points), visible faults (a threshold, which limits the growth of the patch), stop at barriers (a threshold for guiding the growth of the patch, if the barrier value of a candidate extrema point exceeds the threshold, the growth stops) and quality cube. Then the user picks a seed point in the 3D seismic data (Step 302). Also as show in FIG. 4b, the user may preview extrema lines on the vertical section plane (step 304). Previewing extrema lines on the intersection plane gives user more information, which reveals different results according to different parameters of the user input, such as the vertical max slope, confidence or tolerance. In FIG. 4c, the user picks the seed point by manually snapping a point on a vertical section plane of the 3D seismic data.

It will then be determined whether there is an extrema point located within a predetermined distance from the seed point? (Step 305). If there is no extrema point near the seed point, the process will then halt and waiting for another user input of seed point (Step 306). If there is an extrema point near the seed point, the extrema point will be added to a extrema patch as a starting point.

As shown in FIG. 3, it will be determined whether all traces around the extrema patch have been visited? According to one embodiment of the present invention, greedy algorithm is used to grow extrema patches as large as possible. Extrema points located in each surrounding traces will be determined by comparing the character of the starting point. (Step 308). If all the traces around the boundary of the extrema patch have been visited, exporting the extrema patch as a geological horizon (Step 309) and process ends (Step 310), see, for example, FIG. 4d, a new geological horizon is generated and combined to the interpretation collection. If not all the traces around the boundary of the extrema patch have been visited, selecting another trace nearby and extract there from an extrema point near the starting point (Step 311). Then, determining whether the extracted extrema point matches the user-defined parameter. Comparing the Confidence, Max Slop, Visible Fault, Barrier Cube, etc of the extracted extrema point to those of the user-defined parameters (Step 312), if the parameters of the extrema point are within the ranges of the user-defined parameters, the extrema point is considered matching the user-defined parameter. If the extrema point of the nearby trace does not match the user-defined parameter, the process will go back to step 308 to determine is there any other traces around the extrema patch have not been visited. Otherwise, that extracted extrema point will be added to the extrema patch and the starting point will be updated with the extracted extrema point (Step 313). After step 313, step 308 will be repeated to determine whether all traces around the extrema patch have been visited.

According to an embodiment of the invention, parameters inputted by the user in step 203 may also include MinArea, which indicates a user defined threshold area value for extrema patches. In step 309, before exporting the extrema patch as a geological horizon, the extrema patch will be examined with the user defined threshold area value. If the extrema patch is smaller than the user defined threshold, the process will then halt and waiting for the user to input another seed point.

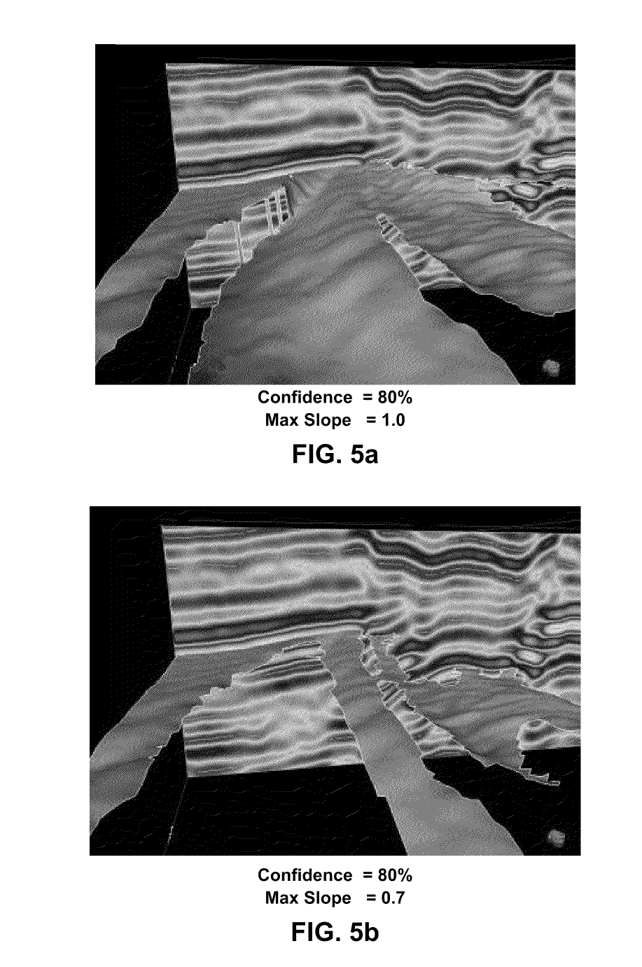

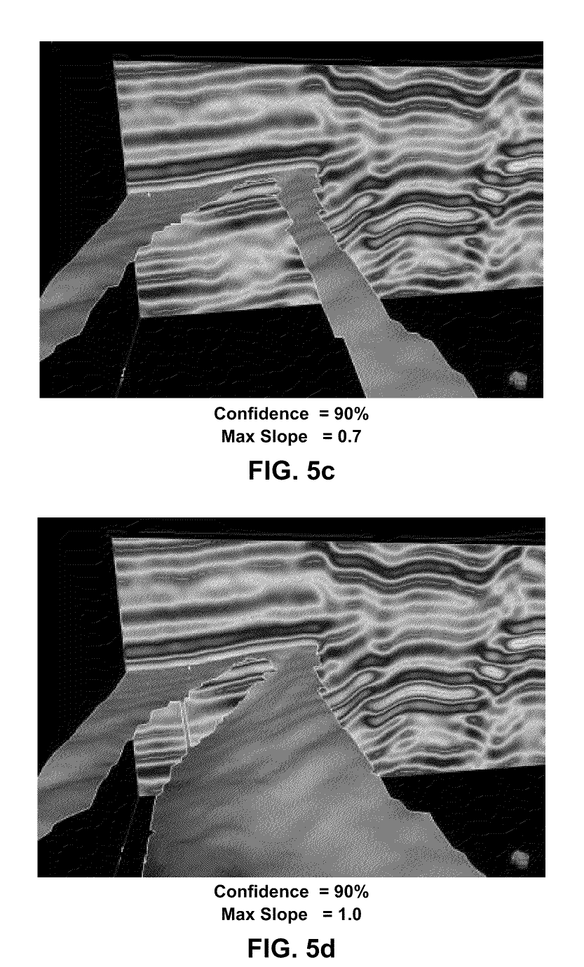

According to one embodiment of the present invention, when comparing an extrema point with the user-defined parameter, various parameters may be considered, for example, but not limited to, Confidence, Max Slop, Visible Fault, Barrier Cube. FIG. 5a-5d illustrate different shapes of geological horizons extracted from the seismic volume by using different parameters as thresholds. As shown in FIG. 5a, the confidence of the newly generated geological horizon is 80% and Max Slope is 1.0, the extracted geological horizon extends from a vertical section along the extrema line. As shown in FIG. 5b, the confidence of the newly generated geological horizon is 80% and Max Slope is 0.7, less extrema points are included in the extracted geological horizon as compared with the geological horizon shown in FIG. 5a. In FIG. 5c, confidence of the newly generated geological horizon is 90% and Max Slope is 0.7, less extrema points are included in the extracted geological horizon as compared with the geological horizon shown in FIG. 5d, when the confidence of the newly generated geological horizon is 80% and Max Slope is 0.7. Thus, by configuring various parameters or the combinations of parameters, a user can manipulates the dynamic horizon extraction process.

Some embodiments of the invention relate to systems that implement the above described methods. A system of the invention may include a processor and a memory that store a program having instructions for causing the processor to perform the steps of a method of the invention. Such systems may be implemented on any computer (such as a personal computer or workstation) or any computing unit known in the art. Some embodiments of the invention relate to computer readable media, which store a program having instructions for causing the processor to perform the steps of a method of the invention.

Advantages of the invention may include one or more of the following. Methods of the invention use dynamic filtering of a large collection of geometric primitives to quickly isolate a desired subset of available geometric primitives. The filtering may be based on proximity to a selected point in 3D as well as a selected property of the object. This will facilitate analysis of complex data set to afford quick identification of useful information.

While the invention has been described with respect to a limited number of embodiments, those skilled in the art, having benefit of this disclosure, will appreciate that other embodiments can be envisioned that do not depart from the scope of the invention as disclosed herein. Accordingly, the scope of the invention shall be limited only by the attached claims.

What is claimed is:

1. A method for extracting geological horizon on-demand from a 3D seismic data set, comprising:
collecting 3D seismic data and generating 3D seismic extrema cubes;
picking a seed point in the 3D seismic data set;
determining a starting extrema point for extracting the geological horizon, wherein the starting extrema point is associated with the seed point;
growing an extrema patch consisting of multiple extrema points from multiple traces, wherein the growth begins from the starting extrema point;
capturing statistics of the growing extrema patch; and
outputting the extrema patch as the geological horizon.

2. The method of claim 1, wherein the statistics being captured from the growing extrema patch includes size, spatial extend, amplitude and attribute trends.

3. The method of claim 1, further comprising incorporating the geological horizon with a new or an existing interpretation collection consisting of existing geological horizons and associated horizon statistics.

4. The method of claim 1 further comprising inputting user defined parameters before determining a starting extrema and guiding the growth of the extrema patch with the parameters.

5. The method of claim 5, wherein the user selected parameters are selected from a group consisting of Confidence, Max Slop, Barrier Cube, Quality Cube and Visible Fault.

6. The method of claim 1, wherein determining a starting extrema point includes choosing an extrema point located within a predetermined distance from the seed point.

7. The method of claim 1, wherein growing the extrema patch comprises extracting extrema points from traces located around the starting extrema point and adding the extracted extrema points to the extrema patch.

8. The method of claim 1, wherein growing the extrema patch comprises determining whether all traces around the boundary of the extrema patch have been visited, and if so, outputting the extrema patch as the geological horizon; and if not all traces around the extrema patch have been visited, selecting a trace nearby and extracting extrema points from the selected trace.

9. The method of claim 8, wherein growing the extrema patch comprises determining whether the extracted extrema points match the user-defined parameters, and if one matches, adding the matching extrema point to the extrema patch; if no extrema point matches, extracting extrema points from another traces and determining whether the extracted extrema points match the user-defined parameters.

10. The method of claim 9, wherein growing the extrema patch comprises repeating the step of determining whether all traces around the boundary of the extrema patch have been visited and updating the starting extrema point with the matching extrema point.

11. A system for analyzing formation property data, comprising a processor and a memory, wherein the memory stores a program having instructions for:
collecting a volume of interest from 3D seismic data;
extracting geological horizon segments that include multiple geological horizons by generating and classifying 3D seismic extrema cubes corresponding to the volume of interest;
dynamic extracting a geological horizon from the 3D seismic data by using a user defined seed point to guide extraction; and
incorporating the geological horizon segments generated from extrema cubes and the geological horizon generated from the seed point.

12. The system of claim 11, wherein dynamic extracting a geological horizon from the 3D seismic data comprises determining a starting extrema point for a horizon, wherein the starting extrema point is associated with the seed point.

13. The system of claim 11, wherein dynamic extracting a geological horizon from the 3D seismic data comprises inputting user defined parameters selected from a group consisting of Confidence, Max Slop, Barrier Cube, Quality Cube and Visible Fault.

14. The system of claim 11, wherein dynamic extracting a geological horizon from the 3D seismic data comprises growing an extrema patch from the starting extrema point.

15. The system of claim 14, wherein growing the extrema patch from the starting extrema comprising:
extracting extrema points corresponding to the starting extrema point from a nearby trace;
determining whether the extracted extrema points match the user-defined parameters, and if one matches, adding the matching extrema point to the growing extrema patch and updating the starting extrema point with the matching extrema point; if it does not match, selecting another trace near the starting extrema, extracting extrema points and determining whether the extracted extrema points match the user-defined parameters; and
if all traces around the boundary of the extrema patch have been visited, outputting the extrema patch as the geological horizon.

16. The system of claim 11 further comprising outputting combined horizon primitives.

17. The system of claim 11, further comprising outputting a combined horizon interpretation collection.

18. A computer-readable medium storing a program having instructions for:
obtaining a user-defined seed point in 3D seismic data and generating 3D seismic extrema cubes;
determining a starting extrema point for extracting a geological horizon, wherein the starting extrema point is associated with the seed point;
growing an extrema patch consisting of multiple extrema points from multiple traces, wherein the growth of the extrema patch begins with the starting extrema; and
outputting the extrema patch as the geological horizon.

19. A computer-readable medium storing a program having instructions for:
collecting a volume of interest from 3D seismic data;
extracting geological horizon segments consisting of multiple geological horizons by generating and classifying 3D seismic extrema cubes corresponding to the volume of interest;
dynamic extracting a geological horizon from the 3D seismic data by using a user defined seed point to guide extraction; and
incorporating the geological horizon segments generated from extrema cubes and the geological horizon generated from the seed point.
